(19) United States
(12) Patent Application Publication
(10) Pub. No.: US 2006/0001633 A1
(43) Pub. Date: Jan. 5, 2006

(54) Display driving device

(75) Inventors: Masami Ebara, Hyogo (JP); Toru Sasaki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/159,407

(22) Filed: Jun. 23, 2005

(30) Foreign Application Priority Data
Jun. 25, 2004 (JP) 2004-187642

(51) Int. Cl. G09G 3/36

(52) U.S. Cl. 345/98

(57) ABSTRACT

A liquid crystal panel receives a Φ2 as an operation clock, and receives a digital video signal (D or E) from a selection circuit. The digital video signal (D or E) is output in a period half a Φ2 period. The operation clock of the panel is the Φ2. Thus, the same dot data (a same-location signal value in the video signal) in the video signal is successively supplied to adjacent two dots aligned horizontally on the liquid crystal panel. At timing of a first field, an input digital video signal (B) is not delayed, and is supplied to the liquid crystal panel 20 as the digital video signal (D). At timing of a second field, the input digital signal B is delayed, and supplied to the liquid crystal panel as a 1-clock-delay video signal (E).

### BACKGROUND OF THE INVENTION

1. Field of the Invention

The present invention relates to a display driving device used for applying a scale-conversion to a video signal and driving a display.

2. Description of the Prior Art

There exist standards such as VGA, XGA, WXGA, and others, for example, regarding the number of dots of a liquid crystal display panel. A resolution of a VGA panel is vertical 480 lines/horizontal 640 dots, and that of an XGA panel is vertical 768 lines/horizontal 1024 dots. Contrary to these, the number of horizontal dots in NTSC, and PAL is 720 dots, and the number of vertical dots in NTSC is 240/field (an encoding parameter of a component signal: ITU-R Rec.601), for example. In these standards, it is necessary that the horizontal and vertical dots are subjected to a scaling process by a scaling circuit in horizontal and vertical directions so as to be converted into horizontal and vertical resolutions of the respective display panels (see Japanese Patent Laying-open No. 2002-244629).

In a case that a frequency for applying sampling to an input video signal is 13.5 MHz, clock frequencies of digital video signals (basically, RGB signals) to be output onto the respective panels are as follows:
The VGA→(640/720)·(480/240)·13.5 MHz=24 MHz
The XGA→(1024/720)·(768/240)·13.5 MHz=61.44 MHz
The WXGA→(1280/720)·(768/240)·13.5 MHz=76.8 MHz

FIG. 5 is a block diagram showing a conventional horizontal scaler 50, and FIG. 6 is a simple operational description of this scaler 50. An input digital video signal (B) is synchronous with a leading edge of a clock Φ1 (A), and is input into a D-type flip-flop 51. In this example, a horizontal scaler clock Φ2 is produced by doubling the clock Φ1 in a doubler 52. In addition, for the sake of simplicity, the number of horizontal dots of the input digital video signal is 640 dots, and the number of horizontal dots of a display panel 60 is 1280 dots in this example.

A digital video signal (D) is the input digital video signal (B) as it is. A digital video signal with a delay of one clock (Hereinafter, briefly referred to as a 1-clock-delay video signal (E) by the Φ2) is an output of the D-type flip-flop 51, and becomes a signal delaying by one clock the digital video signal (D) input in the horizontal scaler 50 at timing of a leading edge of the horizontal scaler clock Φ2. At second leading timing of the horizontal scaler clock Φ2 in FIG. 6, “A0” of the digital video signal (D) is retained and output, and then, becomes an output of the 1-clock-delay video signal (E) by the Φ2. At third leading timing of the horizontal scaler clock Φ2, the digital video signal (D) has not yet become “A1”, and the output of the 1-clock-delay video signal (E) by the Φ2 is still “A0”. At fourth leading timing of the horizontal scaler clock Φ2, the output of the 1-clock-delay video signal (E) by the Φ2 is switched to “A1”, for example.

By using the 1-clock-delay video signal (E) and the digital video signal (D), an interpolating process of a horizontal direction is applied, so that a video signal (1280 dots) (F) is created. More specifically, in this interpolating process, a horizontal interpolating output (F) obtained by adding an output (a value 0.5 times the digital video signal (D)) of a multiplier 53 and an output (a value 0.5 times the 1-clock-delay video signal (E)) of a multiplier 54 by an adder 55 is supplied to the display panel 60. FIG. 7 shows a concept of displaying in the horizontal scaler 50. Video data displayed in each dot a, b, c, d, e, f . . . of the display panel 60 becomes, in order, A0, (A0+A1)/2, A1, (A1+A2)/2 . . . in both first and second fields in the video signal.

Thus, the frequency of the digital video signal to be transmitted to the display panel 60 in the prior art is very high. More particularly, this phenomenon is remarkable in a high-resolution panel, and there is no reliability in a data transmission at a TTL (transistor-transistor logic) level, which results in requiring a transmission according to a transmission standard such as a LVDS (low voltage differential signaling), and others (see Japanese Patent Laying-open No. 2003-152522). In addition, the horizontal scalers (the multiplier 53, the multiplier 54, and the adder 55) become necessary, and therefore, a size of the display driving device for the horizontal scaler 50 becomes large.

### SUMMARY OF THE INVENTION

In view of the above-described circumstances, it is a primary object of the present invention to provide a display driving device capable of lowering a frequency of a digital video signal to be transmitted to a display, and reducing a size of a circuit.

In order to solve the above problem, a display driving device of the present invention is a display driving device for applying a scale conversion to a video signal and driving a display, and comprises a means for successively supplying to a plurality of adjacent dots aligned horizontally on a display a same-location signal value of the video signal, a means for determining a first field and a second field in the video signal, and a means for deviating a writing phase of the video signal of the display depending on the first field or the second field in the video signal.

In the above-described configuration, a same-location signal value of the video signal is successively supplied to a plurality of adjacent dots aligned horizontally on a display, and thus, a frequency of the digital video signal to be transmitted to the display becomes low. A writing phase of the video signal toward dots of the display is deviated (shifted) in relation to the first field or the second field in the video signal, and thus, it is possible to realize a visual increase of the number of horizontal dots, which makes it possible to eliminate a need of a horizontal scaler.

In a display driving device configured as above, one of the two fields, that is, the first field and the second field in the video signal, may be delayed, so that the writing phase is deviated (shifted). In addition, preferably, the display is a hold-type display such as a liquid crystal panel, and others.

According to the present invention, it is advantageous in that it is possible to lower the frequency of the digital video signal to be transmitted to the display in the scale conversion, and reduce a size of the circuit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a display driving device of an embodiment of the present invention;

FIG. 2 is a timing chart showing a process content of a video signal;

FIG. 3 is a descriptive diagram showing a video displaying in each field;

A portion (a) in FIG. 4 is a descriptive diagram showing an input digital video signal (B) in a first field;

A portion (b) in FIG. 4 is a descriptive diagram showing an input digital video signal (B) in a second field;

Portions (c) and (d) in FIG. 4 are descriptive diagrams showing displaying examples in which display phases are deviated (shifted);

A portion (e) in FIG. 4 is a descriptive diagram showing a case that dots are not deviated (shifted), for the sake of reference;

FIG. 5 is a block diagram showing a conventional display driving device (a horizontal scaler);

FIG. 6 is a timing chart showing a content of a conventional process of a video signal; and

FIG. 7 is a descriptive diagram describing a conventional video displaying in each field.

### DESCRIPTION OF THE PREFERRED EMBODIMENTS

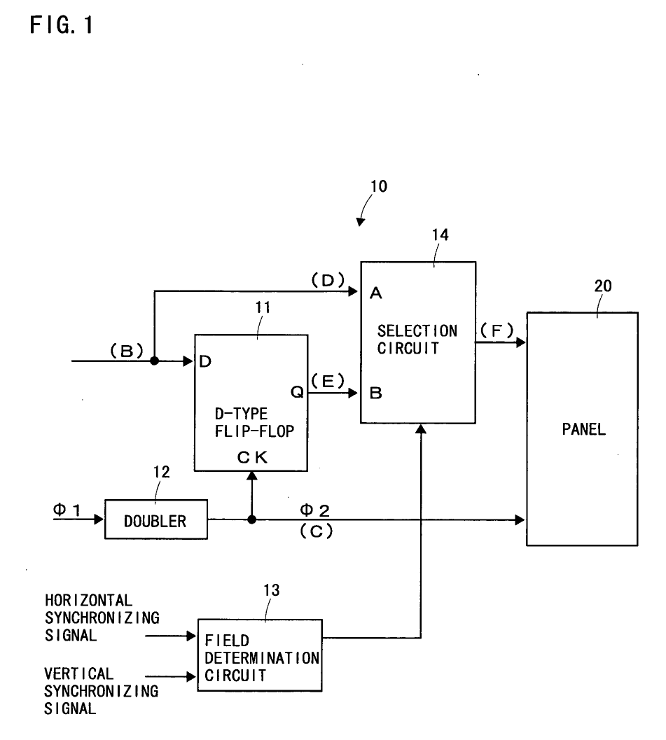

Below, an embodiment of the present invention will be described based on FIG. 1 to FIG. 4.

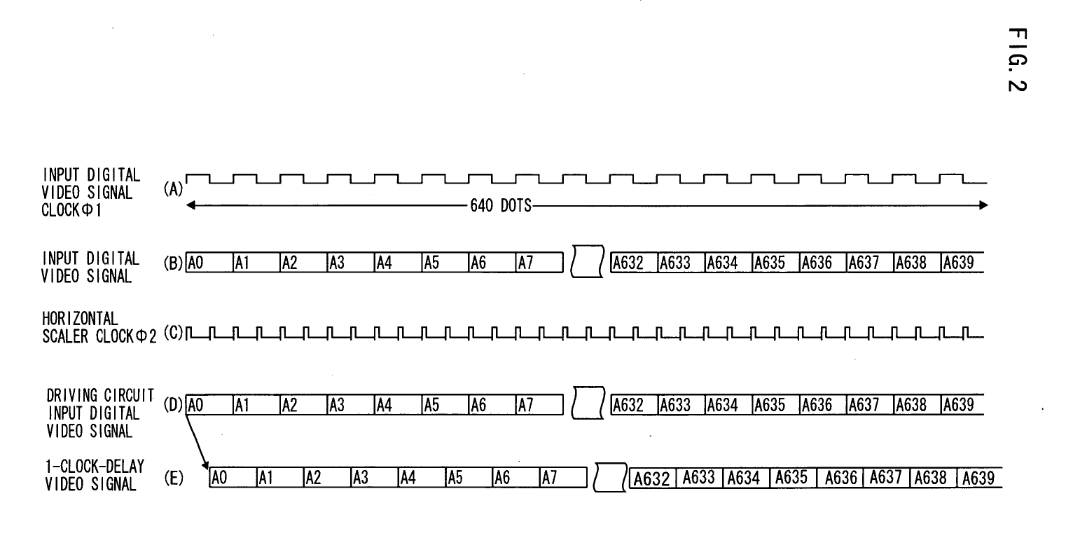

FIG. 1 is a block diagram showing a display driving device 10 and a liquid crystal panel 20, and FIG. 2 is a simple operational description of the display driving device 10. An input digital video signal (B) is synchronous with a leading edge of a clock Φ1 (A), and is input into a D-type flip-flop 11. In this example, a horizontal scaler clock Φ2 is produced by doubling the clock Φ1 in a doubler 12. In addition, for the sake of simplicity, in this example, the number of horizontal dots of the input digital video signal is 640 dots, and the number of horizontal dots of the panel is 1280 dots.

A digital video signal (D) is the input digital video signal (B) as it is. A 1-clock-delay video signal (E) by the Φ2 is an output of the D-type flip-flop 11, and becomes a signal generated by delaying by one clock the digital video signal (B) input in the display driving device 10 at timing of a leading edge of the horizontal scaler clock Φ2. At second leading timing of the horizontal scaler clock Φ2 in FIG. 2, “A0” of the digital video signal (B) is retained and output, and then, the “A0” becomes an output of the 1-clock-delay video signal (E) by the Φ2. At third leading timing of the horizontal scaler clock Φ2, the digital video signal (B) has not yet become “A1”, and the output of the 1-clock-delay video signal (E) by the Φ2 is still “A0”. At fourth leading timing of the horizontal scaler clock Φ2, the output of the 1-clock-delay video signal (E) by the Φ2 is switched to “A1”, for example. Both the digital video signal (D) and the 1-clock-delay video signal (E) are to be output in a period half a Φ2 period.

A field determination (distinction) circuit 13 inputs a horizontal synchronizing signal and a vertical synchronizing signal, and supplies to a selection circuit 14 a switching signal (in a case of a first field, a logic high signal, and in a case of a second field, a logic low signal, for example) indicating whether the first field or the second field.

The selection circuit 14 selects the digital video signal (D) input in a terminal A in a case of the switching signal is the logic high signal, or selects the 1-clock-delay video signal (E) input in a terminal B in a case of the logic low signal, for example.

The liquid crystal panel 20 receives the Φ2 as an operation clock, and receives either the digital video signal (D or E) selected in the selection circuit 14. Although not shown, in a case of an enable signal is high, the selected digital video signal is sequentially shifted in a shift register of the liquid crystal panel 20. In addition, at a time that a shift of the video signal worth 1 line is completed, each data is fetched within a latch circuit by a latch pulse. At this time, if a line number selected in a gate driver line selection circuit not shown is 0 (zero), a video signal that is D/A (digital to analog)-converted is written into a line 0 (zero). Similarly, a line to be selected is sequentially shifted to 1, 2, 3, and an image is displayed on the panel 20.

Herein, the digital video signal (D or E) is output in a period half the Φ2 period. The operation clock of the panel 20 is the Φ2. Thus, same dot data in the video signal (a same-location signal value in the video signal) is successively supplied to adjacent two dots aligned horizontally on the liquid crystal panel 20.

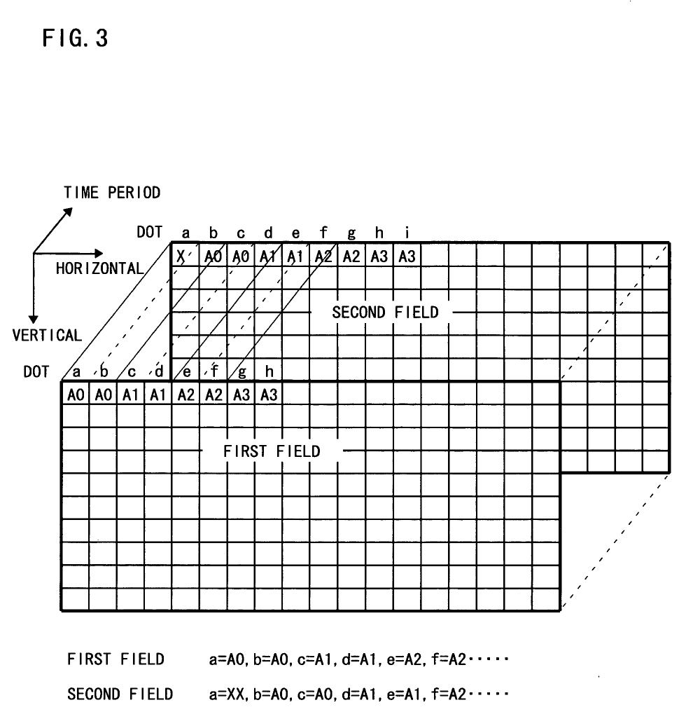

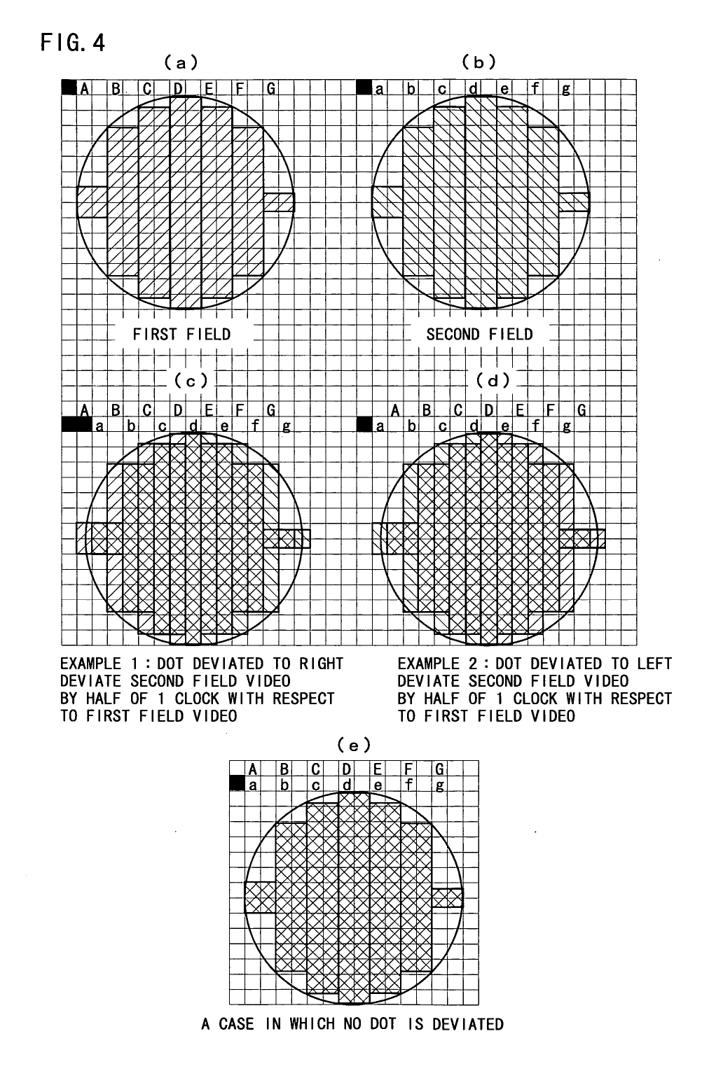

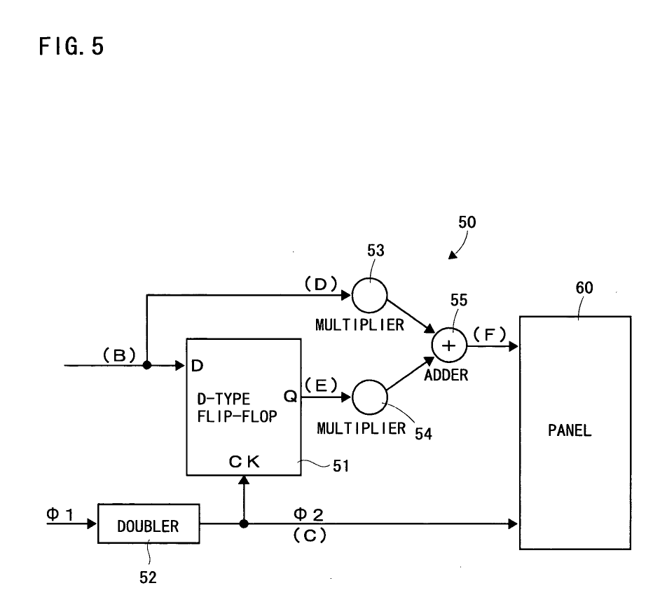

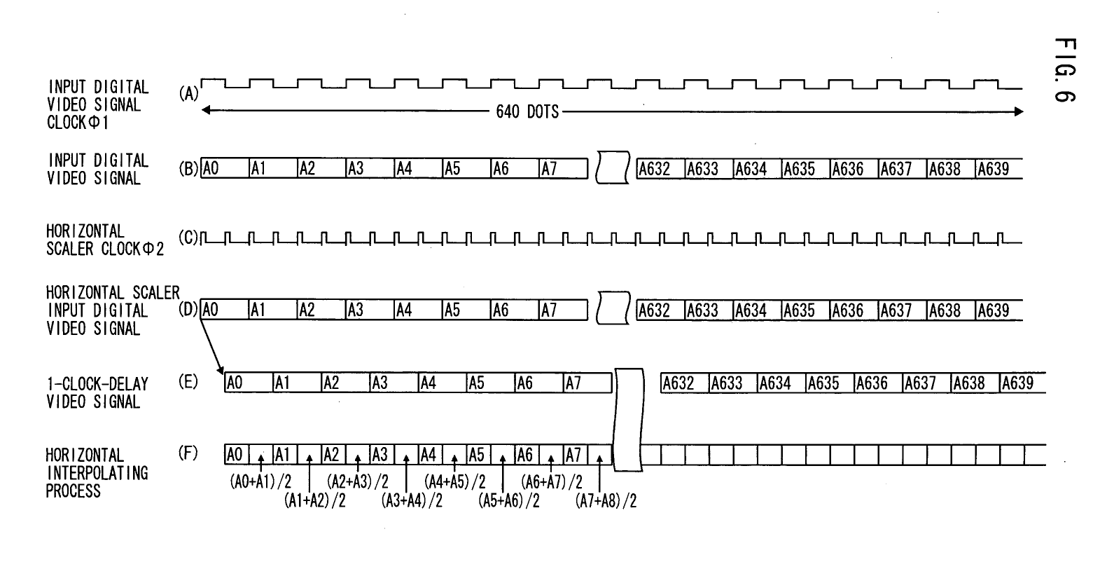

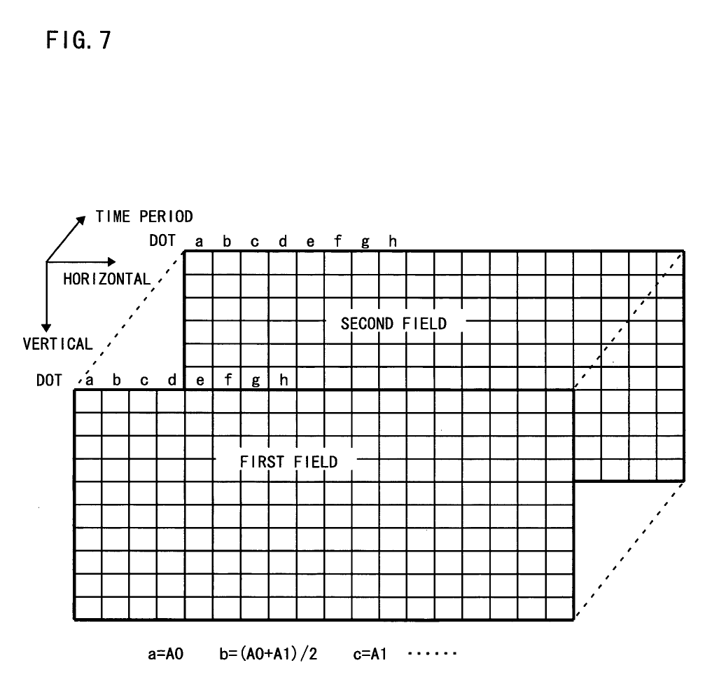

At timing of the first field in the video signal, the input digital video signal (B) in this field is supplied, without being delayed, to the liquid crystal panel 20 as the digital video signal (D). In an example shown in FIG. 3, dot data A0 is written into adjacent dots “a”, “b” at the endmost of the liquid crystal panel 20, and dot data A1 is written into subsequent adjacent two dots “c”, “d”. On the other hand, at timing of the second field, the input digital video signal (B) in this field is delayed, and supplied to the liquid crystal panel 20 as the 1-clock-delay video signal (E). Therefore, as shown in FIG. 3, there is no dot data (xx) with respect to the dot “a” in the second field, the dot data A0 is written into the adjacent dots “b”, “c” of the liquid crystal panel 20, and the dot data A1 is written into the subsequent adjacent two dots “d”, “e”.

A video displaying example by the above-described display driving process is shown in FIG. 4. A portion (a) in FIG. 4 shows the input digital video signal (B) in the first field, and a portion (b) in FIG. 4 shows the input digital video signal (B) in the second field. In a portion (c) in FIG. 4, as a result of the above-described display driving process, a second-field video is deviated (shifted) by half the 1 clock (Φ1) to the right with respect to a first-field video. That is, a visual accumulation effect of the first-field video and the second-field video allows a user to recognize the video in the above-described portion (c) in FIG. 4. It is noted that as shown in a portion (d) in FIG. 4, it may be possible to carry out a process in which the second-field video is deviated (shifted) by half the 1 clock (Φ1) to the left with respect to the first-field video. In addition, for the sake of reference, the video displaying of a case that the dots are not deviated (shifted) is shown in a portion (e) in FIG. 4.

As described above, the display driving device of the present invention eliminates a need of the horizontal scaler in the conventional configuration. That is, a displaying phase (a writing phase) on the panel 20 is deviated (shifted) by 180 degrees (deviated (shifted) half a period of the Φ1) by each field, without increasing the number of horizontal dots to 1280 dots by the horizontal scaler, so that it is made possible to realize a visual increase of the number of horizontal dots. Thus, the horizontal scaler is rendered unnecessary, so that a cost is reduced. In addition, it becomes possible to lower the frequency of the digital video signal to be transmitted to the display panel 20 (in the embodiment, the frequency is reduced by half compared to the prior art), which enables a data transmission to be performed, without relying on the LVDS.

It is noted that in the above-described example, there is no dot data with respect to the dot “a” in the second field. However, it may be possible to adopt a technique in which the dot data A0 in the second field is taken out from the input digital video signal (B), and the dot data A0 is supplied to the liquid crystal display panel 20 during a period of half the Φ2 prior to a selection output of the 1-clock-delay video signal (E) of the second field, for example. Furthermore, in the above description, it is shown an example in which the liquid crystal panel is driven. However, it is not always the case. The display driving device of the present invention becomes capable of improving a video quality especially when in use for driving a so-called hold-type displaying element such as the liquid crystal panel, and others.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. A display driving device for applying a scale conversion to a video signal and driving a display, comprising:
a means for successively supplying to a plurality of adjacent dots aligned horizontally on a display a same-location signal value of said video signal;
a means for determining a first field and a second field in the video signal; and
a means for deviating a writing phase of the video signal of said display depending on the first field or the second field.

2. A display driving device according to claim 1, wherein by delaying one of the two fields, that is, the first field and the second field in the video signal, said writing phase is deviated.

3. A display driving device according to claim 1 or 2, wherein said display is a hold-type display such as a liquid crystal panel, and others.
